(19) United States
(12) Patent Application Publication
(10) Pub. No.: US 2007/0239748 A1
(43) Pub. Date: Oct. 11, 2007

(54) Management of reference data for platform verification

(76) Inventor: Ned M. Smith, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/393,131

(22) Filed: Mar. 29, 2006

(51) Int. Cl. G06F 7/00

(52) U.S. Cl. 707/101

(57) ABSTRACT

Management of reference data to be used for verification of platform is described herein. The reference data may be in the form of reference integrity metrics (RIM) records that describe trusted platform components.

### TECHNICAL FIELD

Embodiments of the present invention relate to the field of data processing, more specifically, to management of reference data for use in verification of data processing platforms.

### BACKGROUND

Advances in processor and networking technology have led to increased networked computing. Before a data processing platform (hereinafter, simply platform) is allowed to access a network, it is typically desirable to verify that the platform is a trustworthy platform that is configured properly (i.e., having all of the proper components that are all properly configured) so that the security of the network is not compromised. That is, an improperly configured platform that is allowed to access a network may cause, for example, the introduction of viruses and/or unauthorized access of the network by third parties through open input/output (I/O) ports. As used herein, a “platform” may refer to the general framework of a data processing or computing device including various hardware, software, and firmware that typically comprise a computing device. A data processing or computing device may be any type of processor based system having various form factors including, for example, personal computers, mobile or desktop, set-top boxes, personal digital assistants (PDAs), web tablets, and so forth.

Thus, prior to being allowed partial or full access to a network, a platform will often communicate with a policy decision point (PDP) in order to authenticate or verify the platform. The PDP facilitates the enforcement of the policy or policies that dictate whether a platform is to be allowed full or partial access to the network. If the platform is not compliant with the policy or policies, the PDP may provide to the platform rule or rules that are used by the platform (e.g., an agent in the platform) in order to take the necessary actions so that it is in compliance with the policy or policies.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a network in accordance with various embodiments of the invention;

FIG. 2 illustrates a policy decision point (PDP) in accordance with various embodiments of the invention;

FIG. 3 illustrates a reference integrity metrics (RIM) record in accordance with various embodiments of the invention;

FIG. 4 illustrates a plurality of RIM records of trusted platform components at a first stage in the evolution of an exemplary platform in accordance with various embodiments of the invention;

FIG. 5 illustrates a plurality of RIM records of trusted platform components at a second stage in the evolution of an exemplary platform in accordance with various embodiments of the invention;

FIG. 6 illustrates a plurality of RIM records of trusted platform components at a third stage in the evolution of an exemplary platform in accordance with various embodiments of the invention;

FIG. 7 illustrates a plurality of RIM records of trusted platform components at a fourth stage in the evolution of an exemplary platform in accordance with various embodiments of the invention;

FIG. 8 illustrates a plurality of RIM records of trusted platform components at a fifth stage in the evolution of an exemplary platform in accordance with various embodiments of the invention; and

FIG. 9 illustrates the relationship between a policy and RIM records in accordance with various embodiments of the invention.

### DETAILED DESCRIPTION OF ILLUSTRATED EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B and C” means “(A), (B), (C), (A and B), (A and C), (B and C) or (A, B and C).” For the purposes of the present invention, the phrase “(A)B” means “(B) or (AB)” that is, A is an optional element.

The description may use the phrases “in various embodiments,” or “in some embodiments,” which may each refer to one or more of the same or different embodiments. Furthermore, the terms “comprising,” “including,” “having,” and the like, as used with respect to embodiments of the present invention, are synonymous.

According to various embodiments of the present invention, systems and methods are provided that manage and use reference data that may be employed for verifications of platforms. The systems may include repositories designed to store the reference data, the reference data being in the form of reference integrity metrics (RIM) records. The RIM records may describe platform components (herein “trusted platform components”) that make up a trusted platform. The word “component” as used herein may refer to hardware, software, and/or firmware that comprises a platform or may refer to the platform itself at different stages in the evolution of the platform. The systems may further include one or more engines operatively coupled to the repository to at least contribute to determining whether to grant full, partial, or no network access to devices seeking accesses to a network, based at least in part on the RIM records. In some embodiments, the system may be part of or coupled to a PDP.

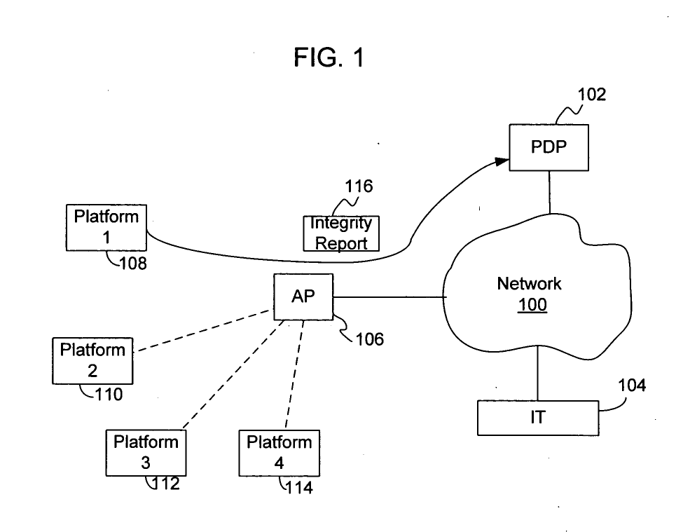

FIG. 1 depicts an exemplary network in accordance with various embodiments of the invention. In some embodiments, the network 100 may be a private network including, for example, a local area network (LAN), a wide area network (WAN), and so forth. The network 100 may be coupled to a PDP 102, an enterprise information technology (IT) department 104, and an access point 106. The access point 106 may facilitate access of the network 100 by platforms 110-114. For the embodiments, a platform 108 desires to access the network 100. In order to have partial or full access to the network 100, the platform 108 may provide an integrity report 116 to the PDP 102. In some embodiments, this may be facilitated by the access point 106, which may give the platform 108 a partial access to the network 100 so that the platform 108 can provide the integrity report 116 to the PDP 102. Alternatively, the integrity report 116 may be directly provided to the PDP 102 without going through the network 100. Note that although the PDP 102 is depicted as being coupled to the network 100, in alternative embodiments, the PDP 102 may not be coupled to the network 100 but instead may only be in communication with the platform 108 and/or the access point 106.

In various embodiments, the integrity report 116 may include information that describes the current configuration of a platform and the various components that make up the platform. Such information may include, for example, information relating to component IDs such as model, make, version, patch, etc., of each of the platform components, and measurements of the components (i.e., integrity and posture information of each of the components). In some embodiments, the concatenation of the make, model, version, and patch may provide a unique identifier, for example, for a program code or transistor logic. In some embodiments, the integrity report 116 may include posture information relating to settings, configuration, installation parameters, and status information of the various components that make up the platform 108.

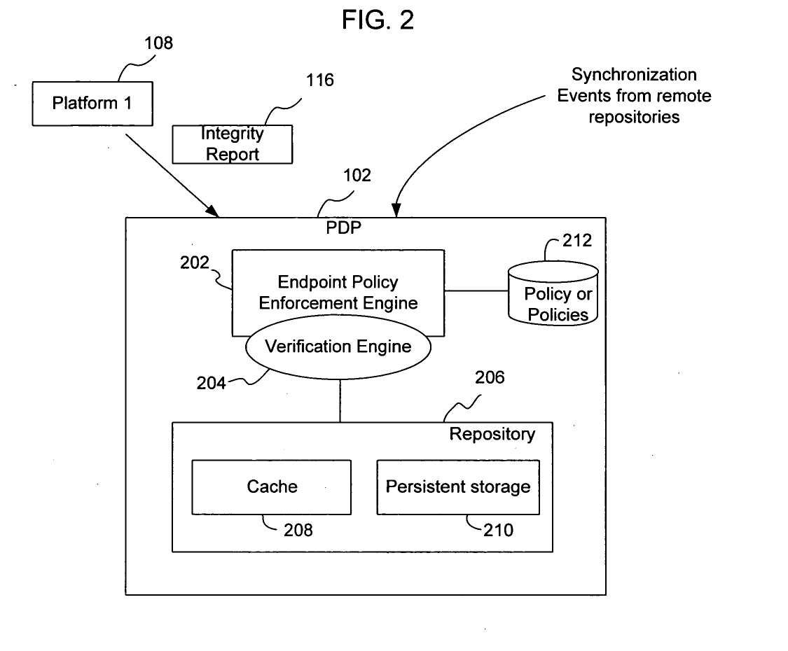

FIG. 2 depicts the PDP 102 of FIG. 1, in further detail, in accordance with various embodiments of the invention. For the embodiments, PDP 102 may include an end point enforcement (EPE) engine 202, an integrity verification engine (or simply “verification engine”) 204, and a repository 206 for storing reference data. In alternate embodiments, one or more of EPE engine 202, verification engine 204, and repository 206 may be remotely disposed, but invocable and/or accessible by PDP 102.

The EPE engine 202 may implement the policy or policies 212 that govern whether the platform 108 is to be allowed partial, full, or no access to the network 100, and to issue rules to the platform 108 when the policy or policies 212 are not complied with. The verification engine 204 may compare the component information of the platform (received e.g. through the integrity report 116) with the reference data stored in the repository 206 in order to determine the difference between the actual configuration of the platform 108 and the configuration of the trusted platform (i.e., ideal or preferred configuration of the platform 108) as described by the reference data stored in the repository 206. That is, the reference data stored in the repository 206 may describe the expected or baseline configuration of the platform 108. In various embodiments, the reference data stored in the repository 206 may be in the form of reference integrity metrics (RIM) records, which will be further described below. Though not explicitly depicted, in an at least partially software/firmware implementation, the PDP 102 may further include a storage medium for storing instructions that enables the engines 202 and 204 to perform the various operation as described herein.

The repository 206 may include a persistent storage 210 for storing at least some of the reference data as well as a cache 208 to store reference data that are to be frequently accessed by the verification engine 204. In some embodiments, the persistent storage 210 may be a flash storage device. Alternatively, the persistent storage 210 may be a mass storage device. Occasionally, the repository 206 may need to be updated with new reference data (i.e., RIM records). This may occur, for example, when a remote repository (such as those maintained by original equipment manufacturers (OEMS) or by an enterprise IT department 104) provides updated reference data to the repository 206 in a process called “synchronization events.” The verification engine 204 in addition to accessing the reference data included in the repository 206 may further maintain the repository 206 by, for example, updating the repository when synchronization events occur and/or by linking the reference data stored in the repository 206 as well as linking reference data to be received during synchronization events. These and other aspects will be described in greater detail below.

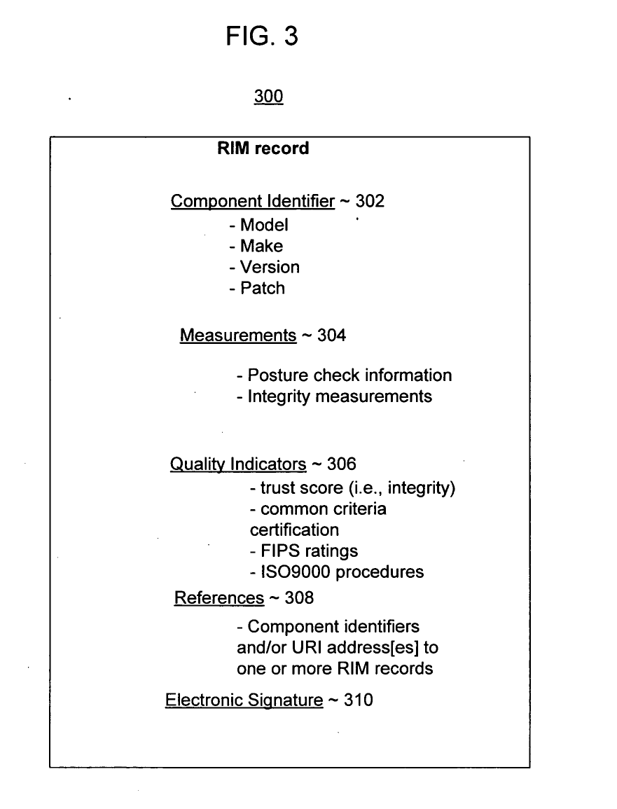

As previously alluded to, the reference data stored in the repository 206 may be in the form of reference integrity metrics (RIM) records. FIG. 3 depicts a RIM record in accordance with various embodiments of the invention. For the embodiments, the RIM record 300 may describe a trusted platform component at a particular stage of the life cycle of the trusted platform component. The word “trusted” as used here refers to a preferred or ideal version of a platform component.

The RIM record 300 may include various data including component identifier 302, reference measurements 304, quality indicators 306, references 308, and an electronic signature 310. The component identifier 302 may be defined by, for example, model, make, version, and patch level of the trusted platform component that is described by the RIM record 300.

The reference measurements 304 indicate one or more desired posture and/or integrity attributes of the trusted platform component. For example, the reference measurements 304 may include posture check information that relate to, for example, manufacturer or IT recommended settings. In some embodiments, posture information that consists of arbitrary or sampled data would not be included in the RIM record 300. The reference measurements 304 may further include integrity measurements that are cryptographic hash of software, firmware or other executable or interpreted code.

The quality indicators 306 indicate the desired quality attributes of the trusted platform component. The quality indicators 306 may include, among other things, a trust score, common criteria certification, federal information processing standards (FIPS) ratings (publication 140-2, published May 25, 2001), and International Organization for Standardization (ISO) 9000 procedures. Note that in various embodiments the quality indicators 306 are not inclusion of the actual specifications cited, but rather flags that indicate whether or not, for example, FIPS or ISO standards have been followed by the issuer of the RIM record 300. In this case, the issuer may be the entity that electronically signs the RIM record 300 such as the manufacturer of the platform component that the RIM record 300 is associated with or may be any entity which issues or re-issues RIM records such as value added resellers (VARs), OEMs, enterprise IT, an integrator, and so forth.

The RIM record 300 may further include one or more references 308 to one or more subordinate RIM records that links the RIM record 300 to the one or more subordinate RIM records. In some embodiments, the references 308 may include the component identifiers 302 and/or the reference addresses of the other RIM records such as Uniform Resource Identifier (URI) addresses or uniform resource locator (URL) addresses thus linking the RIM record 300 to the other RIM records. By linking a group of RIM records together, a trusted platform may be described by the resulting set of linked RIM records. Further, by linking RIM records together that represents various trusted platform components at different stages in the evolution of the trusted platform, the history of the trusted platform may be described by the linked set of RIM records.

The electronic signature 310 in the RIM record 300 may be provided by the originator of the RIM record 300 to provide assurance of the integrity of the RIM record 300. In some embodiments, the originator of the RIM record 300 may be a platform component manufacturer, an enterprise IT department, or some other third party. In some embodiments, the RIM record 300 may be digitally signed so it can be authenticated to their issuer (manufacturer, IT, and so forth). A RIM record 300 signed by its manufacturer may be more authoritative than other signers who cannot vouch for the manufacturing and change control process for the component that is being described by the RIM record 300.

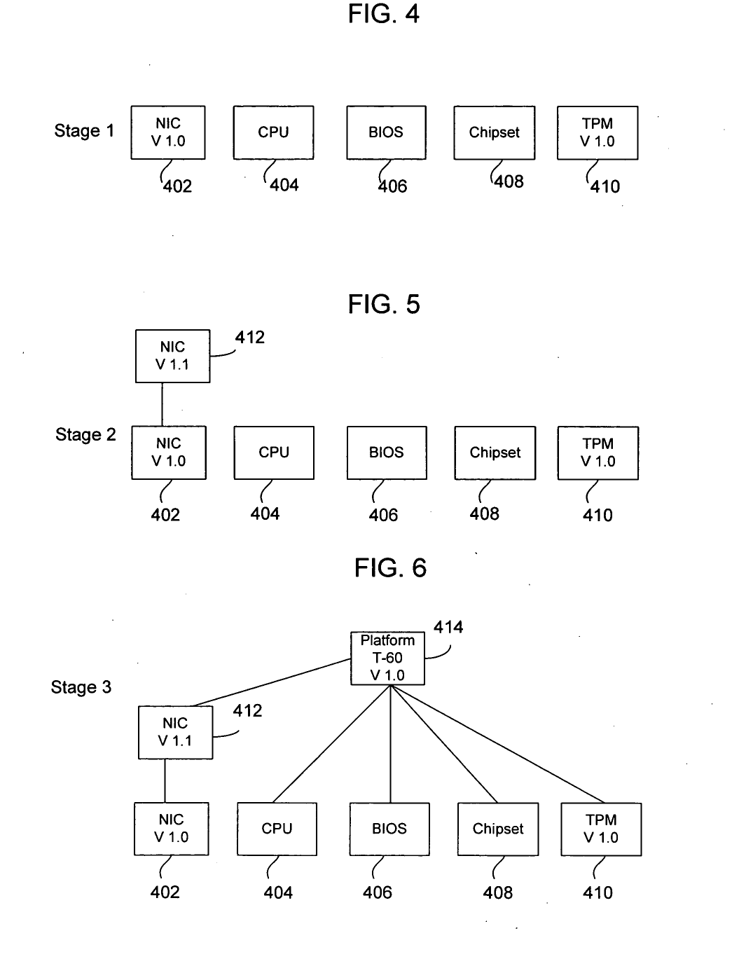

In order to appreciate various aspects of embodiments of the present invention, the following example with references to FIGS. 4-8 are provided that describes the generation and linking of various RIM records during the evolution of an exemplary platform in accordance with various embodiments. In particular, the following example describes how RIM records that describe various trusted platform components may be generated during different stages in the evolution of the exemplary platform. Note that the term “stages” as used herein is to be broadly construed and does not necessarily mean actual stages but may refer to specific point or points in time. In some embodiments, the verification engine 204 of the PDP 102 may receive and link together the generated RIM records. Note, however, that although the following example describes the linking of the generated RIM records is to be generally performed by the verification engine 204, in alternative embodiments, at least some of the linking of the RIM records may be accomplished without the use of the verification engine 204. The linking of RIM records may be accomplished by including, for example, a component identification and/or URL address of a first RIM record into a second RIM record thus linking the second RIM record to the first RIM record. In this case, the second RIM record will be in the “dominate” position relative to the first RIM record, which will be described in greater detail below.

In the first stage in the evolution of the exemplary platform (“platform”), the platform may be made up of separate and detached platform components. Examples of such platform components include, for example, a network interface card (NIC), a central processing unit (CPU), a basic input/output system (BIOS), chipset, a trusted platform module (TPM), and so forth. In the first stage, RIM records for each of these components may be generated and provided by, for example, the manufacturers of these components.

FIG. 4 depicts five example RIM records 402-410 for five exemplary platform components, NIC version 1.0, CPU, BIOS, chipset, and TPM version 1.0, as shown. Note that some of these exemplary platform components (e.g., NIC version 1.0 and TPM version 1.0) will be described herein as being different “versions” in order to further facilitate understanding of various embodiments of the present invention. These RIM records 402-410 may be comprised of various data including, for example, reference measurements, quality indicators, and references (e.g., as depicted in FIG. 3). The RIM records 402-410 may be generated in the form of certificates such as x.509 certificates, XML documents, or other markup that includes a component ID. Each of the RIM records 402-410 may be signed to protect integrity and authenticity. The signatures, which may be applied by the component's manufacturers, may indicate the intended trustworthiness of the RIM records 402-410. In some embodiments, upon the RIM records 402-410 being generated by the manufacturers, the RIM records 402-410 may then be stored in the repository 206 by the verification engine 204 of the PDP 102.

In the second stage in the evolution of the platform, a patch for the NIC is provided by the NIC manufacturer. Consequently, the NIC manufacturer may generate a new RIM record 412 for the NIC patch (NIC version 1.1). In some embodiments, the new RIM record 412 for the NIC patch may originate from a remote repository such as a repository maintained by the NIC manufacturer. The new RIM record 412 may then be provided to the PDP 102 in a synchronization event. Upon receiving the new RIM record 412, the verification engine 204 may store the new RIM record 412 in the repository 206 and link the new RIM record 412 to the RIM record 402 of the NIC (i.e., NIC version 1.0) as depicted in FIG. 5, in accordance with various embodiments of the invention. The linking of the new RIM record 412 to the RIM record 402 of the NIC may be accomplished by including the component identifier of the RIM record 402 into the new RIM record 412. Alternatively, or supplementing the component identifier of the RIM record 402, a reference address such as a local URI address of the RIM record 402 may be included in the new RIM record 412 thus linking RIM record 412 to RIM record 402. Note that in alternative or the same embodiments, the PDP 102 may receive RIM records 402 and 412 that are already linked together as will be described below.

In the third stage in the evolution of the platform, the platform components are assembled together by a computer manufacturer. The computer manufacturer may generate a new RIM record 414 for the assembled platform (T-60, version 1.0), which may be provided to the PDP 102 in another synchronization event. Upon receipt of the new RIM record 414, the verification engine 204 may take the new RIM record 414, store it in the repository 206, and link it to the other RIM records 402-412 as depicted in FIG. 6, in accordance with various embodiments of the invention. The new RIM record 414 may be linked to the other RIM records 402-412 by including the component identifiers and/or reference addresses of RIM records 404-412 into the new RIM record 414. Note, however, that the new RIM record 414 may be linked to RIM record 402 even though the new RIM record 414 does not particularly reference RIM record 402. This is because RIM record 402 is already linked to RIM record 412. Thus, so long as the new RIM record 414 is linked to RIM record 412, it will also be linked to RIM record 402. In FIG. 6, the RIM record 414 has a dominate/subordinate relationship with the other RIM records 402-412 (i.e., RIM record 414 being dominate to subordinate RIM records 402-412). The relevance of the dominate/subordinate relationship will be described in greater detail below.

In alternative embodiments, the computer manufacturer may provide all of the RIM records 402-414 to the PDP 102 rather than having the verification engine 204 receive each of the RIM records 402-414 individually one by one from the component manufacturers and linking the individual RIM records 402-414 together. For these embodiments, RIM records 402-414 may already be linked together when they are received by the PDP 102 in which case the reference addresses that may be included in the dominant RIM records 412 and 414 (i.e., the reference addresses included in the dominate RIM records 412 and 414 that link the dominant RIM records 412 and 414 to subordinate RIM records 402-410) may be changed or supplemented with the local addresses of the subordinate RIM records 402-410. For example, the reference URI address of RIM record 412 that is already included in the RIM record 414 when the RIM record 414 is received by the verification engine 204 may be changed or supplemented with the local address of RIM record 412.

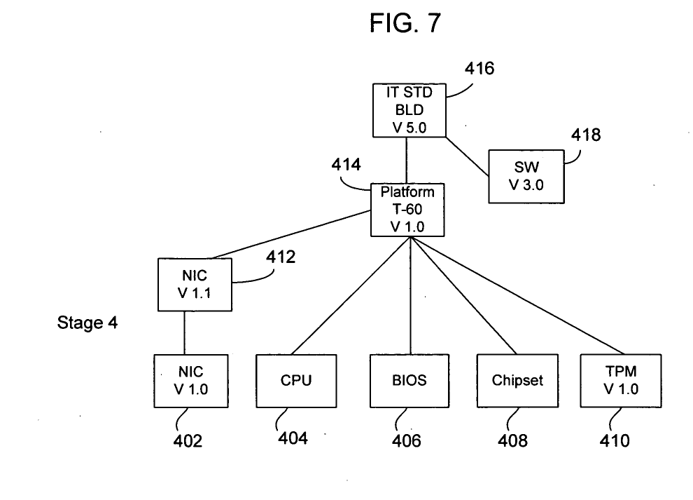

In the fourth stage in the evolution of the platform, the platform is sent to an enterprise IT department, which adds software (SW version 3.0) to the platform. In response, the enterprise IT department may generate a new RIM record 418 for the software as well as a new RIM record 416 for the platform (IT standard build version 5.0) that are received by the PDP 102 (i.e., verification engine 204). The verification engine 204 may then link the received RIM records 416 and 418 to RIM record 414 as depicted in FIG. 7, in accordance with various embodiments of the invention. In some embodiments, the new RIM records 418 and 416 that are received by the PDP 102 may already be linked together by having the reference address of RIM record 418 for the software included in the RIM record 416 of the platform (IT standard build version 5.0). However, such a reference address included in RIM record 416 may be changed or supplemented with a local reference address of RIM record 418 once the two RIM records 416 and 418 are received by the PDP 102. Upon receipt of the new RIM records 416 and 418, the verification engine 204 may store the new RIM records 416 and 418 to the repository 206, and as previously alluded to, link at least the new RIM record 416 to RIM record 414. If the new RIM records 416 and 418 were not already linked together when the RIM records 416 and 418 were received by the PDP 102, then the verification engine 204 may also link the two new RIM records 416 and 418 together. Note that RIM record 416 has a dominate/subordinate relationships with both RIM records 418 and 414.

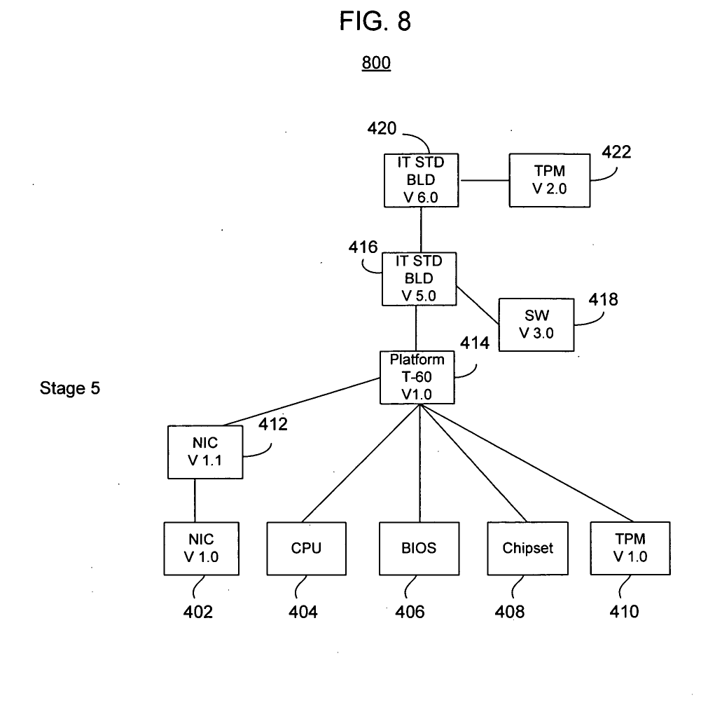

In the fifth stage in the evolution of the platform, the TPM manufacturer provides a new version of the TPM (i.e., TPM version 2.0). Consequently, the TPM manufacturer generates a new RIM record 422 for the new version of the TPM. The new RIM record 422 may be provided directly to the PDP 102 (i.e., verification engine 204) or may be provided to a third party such as an enterprise IT department. In response to the new RIM record 422, the enterprise IT department may generate a new RIM record 420 for a new version of the platform (IT standard build version 6.0). The new RIM records 420 and 422 may then be provided to the PDP 102 where the verification engine 204 stores the new RIM records 420 and 422 and links RIM record 420 to RIM records 422 and 416 as depicted in FIG. 8, in accordance with various embodiments of the invention. Alternatively, the enterprise IT department may initially link the RIM records 420 and 422 before sending the RIM records 420 and 422 to the PDP 102. Under such circumstances, the verification engine 204, upon receipt of the already linked RIM records 420 and 422 may change the reference address of RIM record 422 included in the RIM record 420 with the local reference address of RIM record 422, and link RIM record 420 to RIM record 416.

The structure depicted in FIG. 8, for purposes of this description, may be referred to as a RIM structure 800. In essence, the RIM structure 800 represents the entire history of a trusted platform. The RIM records 402-422 describe various trusted platform components at different stages of the life cycles of the trusted platform components. For example, RIM records 420 and 416 describe the trusted platform (IT standard build versions 5.0 and 6.0) at two different stages of the life cycle of the trusted platform. Similarly, RIM records 422 and 410 describe the trusted TPM (TPM versions 1.0 and 2.0) at two different stages in the life cycle of the trusted TPM.

The dominate/subordinate relationships between the various RIM records within the RIM structure 800 means that some of the RIM records may be effectively superseded or replaced by other RIM records in the RIM structure 800. For example, RIM record 420 has a dominate relationship with RIM record 416 in the RIM structure 800, both of which relate to the platform at different stages of the platform (i.e., IT standard build versions 5.0 and 6.0). Thus, RIM record 420 supersedes RIM record 414, and in effect, replaces RIM record 416 in the RIM structure 800. Note that although RIM record 420 supersedes RIM record 416, effectively replacing it in the RIM structure 800, RIM record 416 is not destroyed. Similarly, RIM record 422 (TPM version 2.0) has a dominate relationship with RIM record 410 (TPM version 1.0), both of which relate to the same platform component but at different stages of the TPM life cycle. Therefore, RIM record 422 effectively replaces RIM record 410 in the RIM structure 800 but does not destroy it. Thus, by removing the reference to RIM record 422 (TPM version 2.0) contained in RIM record 420 (IT standard build version 6.0), for example, the RIM record 410 of the previous version of the TPM (e.g., TPM version 1.0) can be referenced again in the RIM structure 800. In contrast, RIM record 412 (NIC version 1.1) is only associated with a patch for the NIC. Therefore, RIM record 412 does not replace RIM record 402 (NIC version 1.0) and only supplements it in the RIM structure 800.

The RIM structure 800, in effect, describes the entire history of a trusted platform. As can be seen, the RIM structure 800 may be continually updated as the platform evolves without destroying or eliminating older subordinate RIM records.

Although in the above example the RIM records 402-422 of the RIM structure 800 was being continuously provided to the PDP 102 (i.e., verification engine 204) as the exemplary platform was evolving, in alternative embodiments, all of the RIM records 402-422 may be provided together to the PDP 102 at the end of the evolution of the exemplary platform.

Referring back to FIG. 3, the repository 206 may include multiple RIM structures (e.g., RIM structure 800) for multiple trusted platforms. Thus, each RIM record stored in the repository 206 may be referenced by a number of other RIM records belonging to different RIM structures. Since some RIM records will be accessed more frequently than others, the RIM records that are accessed more frequently (i.e., “hot” RIM records) may be stored in the cache 208 in order for such RIM records to be more easily accessed.

In order to determine which of the RIM records are being accessed more frequently, the verification engine 204 may be designed to keep track of the number of RIM records that will reference each of the RIM records stored in the repository 206 and/or how often each of the RIM records are actually being accessed. For purposes of this description, the number of times that a RIM record is referenced by other RIM records will be referred to as a “count.” In some embodiments, the verification engine 204 may be designed to transfer the count of a first RIM record to a second RIM record. This feature may be useful when a new RIM record is added to the repository 206 that replaces another RIM record in the repository 206. For example, suppose the RIM record 410 for TPM in FIG. 8 is a RIM record that is being accessed by many other RIM records. When RIM record 422 is added to the repository 206 and replaces RIM record 410, the count for RIM record 410 may be transferred to the RIM record 422. In doing so, the new RIM record 422 is designated as being a hot RIM record, thus being placed into the cache 208.

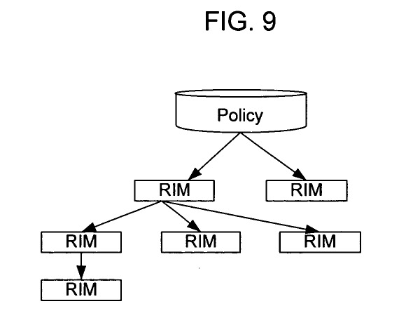

FIG. 9 depicts the relationship between policy or policies 212 and RIM records in accordance with various embodiments of the invention. A policy may consist of a set of rules whose nouns (i.e., attributes) are expressed using RIM records. Thus, in some embodiments, a policy may simply point to one or more RIM records stored in the repository 206. When a policy or policies 212 are to be implemented by the EPE engine 202, the verification engine 204 may simply access selected RIM records (stored in the repository 206) that are identified by the policy or policies 212.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An apparatus, comprising:
a repository to store reference data including a plurality of reference integrity metrics (RIM) records describing a plurality of trusted platform components; and
one or more engines operatively coupled to the repository to at least contribute to determining whether to grant full, partial or no network access to devices seeking access to a network, based at least in part on the RIM records.

2. The apparatus of claim 1, wherein the RIM records are linked, with each of one or more RIM records having one or more reference addresses and/or one or more component identifiers of one or more other RIM records.

3. The apparatus of claim 2, wherein the RIM records include at least a first RIM record linked to a second RIM record, the first and the second RIM records describing a first and a second trusted platform component respectively, the first RIM record being in a more dominant position to the second RIM record resulting in the first RIM record effectively superseding the second RIM record.

4. The apparatus of claim 3, wherein the first trusted platform component is at a first stage of a life cycle of the first trusted platform component, and the second trusted platform component is the same first trusted platform component at a second stage of the life cycle of the first trusted platform component, the second stage being a later stage than the first stage in the life cycle of the first trusted platform component.

5. The apparatus of claim 4, wherein the first RIM record is linked to the second RIM record through at least a third RIM record.

6. The apparatus of claim 4, wherein the RIM records further include a third and a fourth RIM records, the third and fourth RIM records describing a third and a fourth trusted platform components, respectively, the first RIM record further linked to the third RIM record, and the second RIM record further linked to the fourth RIM record, the fourth RIM record being in a more dominant position to the third RIM record resulting in the fourth RIM record effectively superseding the third RIM record.

7. The apparatus of claim 2, wherein the linked RIM records comprise a first, a second, and a third RIM record, the first RIM record linked to the second and the third RIM record, and being in a more dominant position to the second and the third RIM records.

8. The apparatus of claim 1, wherein at least one of the RIM records stored in the repository comprises one or more reference measurements that indicate one or more desired postures and/or integrity attributes of a trusted platform component.

9. The apparatus of claim 1, wherein at least one of the RIM records stored in the repository includes make, model, version, and/or patch information of a trusted platform component.

10. The apparatus of claim 1, wherein at least one of the RIM records stored in the repository includes a quality indicator that indicates a desired quality attribute of a trusted platform component.

11. The apparatus of claim 1, wherein the one or more engines comprise a verification engine operatively coupled to the repository, and adapted to compare actual platform information of a platform with a linked set of RIM records stored in the repository to determine whether there are any differences between the actual platform information and the linked set of RIM records.

12. The apparatus of claim 11, wherein the verification engine is adapted to receive the actual platform information of the platform through an integrity report transmitted by the platform.

13. The apparatus of claim 11, wherein the verification engine is further adapted to add additional RIM records to the repository and to link the additional RIM records to one or more of existing RIM records in the repository.

14. The apparatus of claim 11, wherein the one or more engines comprise an enforcement engine adapted to grant full, partial, or no access to the devices based at least in part on one or more policies.

15. The apparatus of claim 1, wherein the one or more engines comprise an enforcement engine adapted to grant full, partial, or no access to the devices based at least in part on one or more policies.

16. A method, comprising:
storing a plurality of reference integrity metrics (RIM) records describing trusted platform components; and
at least contribute to determining whether to grant full, partial, or no network access to devices seeking access to a network, based at least in part on the RIM records.

17. The method of claim 16, further comprising linking the RIM records together by including in each of one or more RIM records, one or more reference addresses and/or one or more component identifiers of one or more other RIM records.

18. The method of claim 17, wherein said linking comprises linking at least a first RIM record to a second RIM record, the first and the second RIM records describing a first and a second trusted platform component, respectively, the first RIM record being in a more dominant position to the second RIM record resulting in the first trusted platform component effectively superseding the second trusted platform component.

19. The method of claim 18, wherein the first trusted platform component is at a first stage of a life cycle of the first trusted platform component, and the second trusted platform component is the same first trusted platform component at a second stage of the life cycle of the first trusted platform component, the second stage being a later stage than the first stage in the life cycle of the first trusted platform component.

20. The method of claim 19, wherein said linking at least a first RIM record to a second RIM record comprises linking the first RIM record to the second RIM record through at least a third RIM record.

21. The method of claim 19, wherein said linking comprises linking the first and the second RIM records to a third and a fourth RIM records, respectively, the third and the fourth RIM records describing a third and a fourth trusted platform components, respectively, the fourth RIM record being in a more dominant position to the third RIM record resulting in the fourth RIM record effectively superseding the third RIM record.

22. The method of claim 17, wherein said linking comprises linking a first RIM record to a second and a third RIM record, the first RIM being in a more dominant position to the second and the third RIM record.

23. An article of manufacture, comprising:
a storage medium; and
a plurality of instructions stored in the storage medium, to enable one or more engines of a system to perform a plurality of operations, the system having in addition to the one or more engines, a repository storing reference data including a plurality of reference integrity metrics (RIM) records describing a plurality of trusted platform components, the one or more engines operatively coupled to the repository to at least contribute to determining whether to grant full, partial or no network access to devices seeking accesses to a network, based at least in part on the RIM records, and the operations include:
comparing actual platform information of a platform with a linked set of RIM records stored in the repository to determine whether there are any differences between the actual platform information and the linked set of RIM records.

24. The article of claim 23, wherein the operations further comprise receiving the actual platform information of a platform through an integrity report transmitted by the platform.

25. The article of claim 23, wherein the operations further comprise adding additional RIM records to the repository and to link the additional RIM records to one or more existing RIM records.

26. The article of claim 23, wherein the operations further comprise granting full, partial, or no access to the devices based at least in part on one or more policies.

27. The article of claim 23, wherein the operations further comprise evaluating RIM records stored in the repository and/or additional RIM records to be added to the repository to determine whether they are acceptable or not acceptable to one or more policies.

28. A system, comprising:
a repository including a mass storage device, to store reference data including a plurality of reference integrity metrics (RIM) records describing a plurality of trusted platform components, one or more of the RIM records stored in the mass storage device; and
one or more engines operatively coupled to the repository to at least contribute to determining whether to grant full, partial or no network access to devices seeking accesses to a network, based at least in part on RIM records stored in the repository.

29. The system of claim 28, wherein said repository further comprises a cache to store at least RIM records to be accessed more frequently than the one or more RIM records stored in the mass storage device.

30. The system of claim 28, wherein at least a subset of the RIM records are linked together, with each of one or more linked RIM records having one or more reference addresses and/or one or more component identifiers of one or more other linked RIM records.
